(19) United States
(12) Patent Application Publication
(10) Pub. No.: US 2006/0076170 A1
(43) Pub. Date: Apr. 13, 2006

(54) Powered golf bag vehicle with speed control

(76) Inventor: Wang Guohua, Dongguan City (CN)

Correspondence Address: A.M. (ANDY) ARISMENDI, P.O. BOX 35512, HOUSTON, TX, 77235-5512, US

(21) Appl. No.: 11/018,581

(22) Filed: Dec. 21, 2004

(30) Foreign Application Priority Data
Oct. 12, 2004 (CN) 2004201185577

(51) Int. Cl. B62D 51/04

(52) U.S. Cl. 180/19.1

(57) ABSTRACT

A powered golf bag vehicle with speed control includes a drive portion comprising a battery case, a built-in motor, a drive wheel and its accessories, a speed control portion comprising a speed regulator, an optical counter, a PC circuit board and its accessories, a main body portion comprising a frame, a golf bag supporter, a golf bag holder, a battery case and its accessories, a foldable portion comprising a foldable handle with latching device, a foldable support with connecting rod and its accessories, a traveling portion comprising a drive wheel, a wheel, a wheel axle and its accessories, wherein the traveling portion and the foldable portion carrying the main body portion accomplish a traveling movement of the vehicle through the driving force of the drive wheel with moving speed preset and controlled by the speed control portion. Undesirable affects by grasses, water and mud are avoided by enclosing the drive portion into an inner space form by a combination of folded tire and boss.

### BACKGROUND OF INVENTION

The present invention relates to a golf bag vehicle, and more particularly to a powered golf bag vehicle with speed control.

With the popularity of the golf activities, more and more people in China have began to enjoy playing golf games.

At present there are 167 golf courses in China. The booming of golf activities has greatly promoted the development of the golf equipment. As an equipment most commonly used in golf activities, powered golf bag vehicles of various structures are developing very fast.

The conventional golf bag vehicles have the following problems:

1. they are heavy and not convenient to carry;

2. they are driven by rear wheels with complex structure of gears which produces loud noise during operation.

3. they are inconvenient for maintenance.

It is obvious from the above that conventional golf bag vehicles have problems to be solved. Various efforts have been made in order to solve these problems without success. In view of the above problems of the conventional golf bag vehicles, the inventor of the present invention has developed a powered golf vehicle with speed control to solve the above problems.

### SUMMARY OF INVENTION

The object of the present invention is to overcome the inconvenience and defects of the conventional golf bag vehicle and provide a powered golf vehicle with speed control of novel structure that can avoid adverse effects to the driving portion by foreign matters such as grass, water and mud, while at the same time the vehicle according to the present invention is convenient to store and carry.

The objects of and problems to be solved by the present invention are achieved with the following technical solutions. A powered golf bag vehicle according to the present invention comprising: a drive portion, a speed control portion, a main body portion, a foldable portion, and a traveling portion, wherein the main body portion is supported by the traveling portion and the foldable portion, the foldable portion is coupled to an upper part of the main body portion, the drive portion is connected to the traveling portion, and the traveling speed of the vehicle is predetermined and controlled by means of the speed control portion provided on the upper end of the main body portion and the traveling portion.

The objects of and problems to be solved by the present invention are further achieved with the following technical solutions.

Said powered golf bag vehicle with speed control, wherein said drive portion includes a battery case, a built-in motor and a drive wheel. The main body portion includes a frame, a golf bag supporter, a golf bag holder and a battery case. The foldable portion includes a foldable handle with latching device, a foldable support with connecting rod. The traveling portion includes a drive wheel, a wheel and a wheel axle.

Said powered golf bag vehicle with speed control according to the present invention, wherein said drive wheel comprises a tire, a boss, a friction ring coupled to the boss, an axle bearing, a wheel axle, a motor and a bracket for the motor and is enclosed in a space formed by the folded tire and the boss, wherein the motor is provided with a output axis reaching out at the two ends thereof and is coupled to the bracket for the motor coupled to the wheel axle connecting to the boss through the rolling bearing.

Said powered golf bag vehicle with speed control, wherein a rolling friction face is formed on said friction ring along the inner circumference thereof.

Said powered golf bag vehicle with speed control, wherein said speed control portion includes a speed regulator, an optical counter provided on the output axis of the motor and a PC circuit board provided with a case.

From the above one can know that the present invention includes a drive portion comprising a battery case, a built-in motor, a drive wheel and its accessories, a speed control portion comprising a speed regulator, an optical counter, a PC circuit board and its accessories, a main body portion comprising a frame, a golf bag supporter, a golf bag holder, a battery case and its accessories, a foldable portion comprising a foldable handle with latching device, a foldable support with connecting rod and its accessories, a traveling portion comprising a drive wheel, a wheel, a wheel axle and its accessories, wherein the traveling portion and the foldable portion carrying the main body portion accomplish a traveling movement of the vehicle through the driving force of the drive wheel with moving speed preset and controlled by the speed control portion.

The powered golf bag vehicle with speed control according to the present invention has at least the following advantages:

1. The drive portion according to the present invention is enclosed within the space formed by the tire and the boss so that the bad effects by foreign matters such as grasses, water and mud are avoided.

2. The traveling speed of the vehicle according to the present invention can be preset according the working conditions.

3. The control system can make the traveling speed restored to the preset speed when the moving speed of the vehicle according to the present invention changes under various conditions.

4. The vehicle according to the present invention is convenient to store and carry by folding the foldable handle, the latching device, the support and the connecting rod.

### BRIEF DESCRIPTION OF DRAWINGS

FIG. 1 is a schematic view of the extended vehicle according to the present invention.

FIG. 2 is a schematic view of the folded vehicle according to the present invention.

FIG. 3 is a schematic view showing a loaded vehicle according the present invention.

FIG. 4 is a schematic view of the drive wheel of the built-in motor according to the present invention.

FIG. 5 is a view showing the construction of the drive wheel of the built-in motor of an embodiment according to the present invention.

FIG. 6 is a view showing the construction of the drive wheel of the built-in motor of another embodiment according to the present invention.

FIG. 7 is a schematic view of the speed regulator according to the present invention.

FIG. 8 is a view showing the construction of the speed regulator according to the present invention.

FIG. 9 is a block view of the PC control system according to the present invention.

1 - - - frame

2 - - - golf bag support

3 - - - golf bag holder

4 - - - foldable handle and latching device

5 - - - foldable support with connecting rod

6 - - - wheel

7 - - - battery case

8 - - - case for PC circuit board

9 - - - built-in motor drive wheel

10 - - - speed regulator

901 - - - tire

902 - - - boss

903 - - - friction ring

9031 - - - friction face

904 - - - axle bearing

905 - - - wheel axle

906 - - - bracket for motor

907 - - - motor

9071 - - - output axis

1001 - - - enclosure

1002 - - - power switch

1003 - - - indicator

1004 - - - speed regulating knob

1005 - - - circuit board for control interface

1006 - - - variable resistor for speed control

1007 - - - optical counter

### DETAILED DESCRIPTION

More detailed description of the preferred embodiment of the powered golf bag vehicle with speed control will be given below with reference to the drawings.

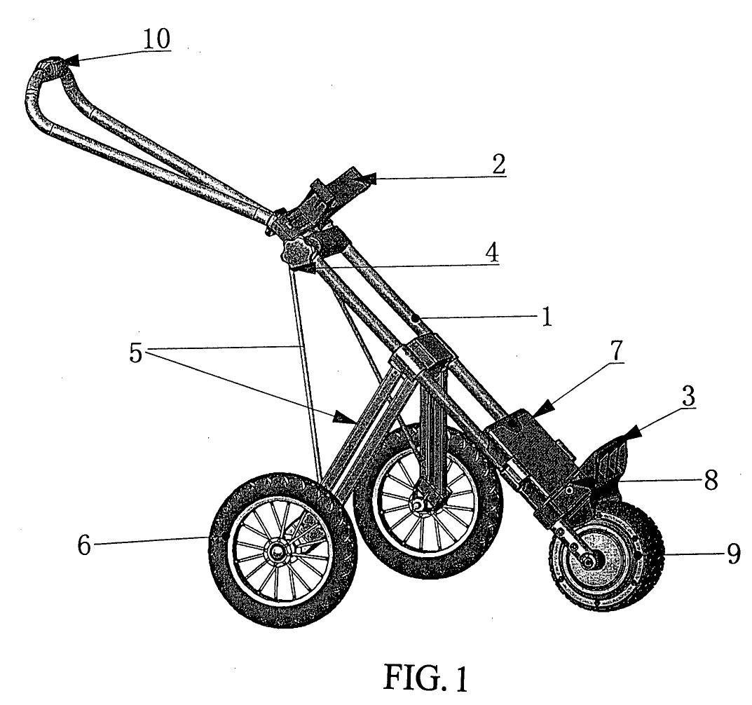

Now, referring to FIGS. 1, 5 and 6, the powered golf bag vehicle with speed control according to the present invention includes a drive portion comprising a battery case 7, a built-in motor 907, a drive wheel and its accessories, a speed control portion comprising a speed regulator 10, an optical counter 1007, a PC circuit board and its accessories, a main body portion comprising a frame 1, a golf bag supporter 2, a golf bag holder 3, a battery case 7 and its accessories, a foldable portion comprising a foldable handle with latching device 4, a foldable support with connecting rod 5 and its accessories, a traveling portion comprising a drive wheel, a wheel 6, a wheel axle 905 and its accessories, wherein the traveling portion and the foldable portion carrying the main body portion accomplish a traveling movement of the vehicle through the driving force of the drive wheel with moving speed preset and controlled by the speed control portion.

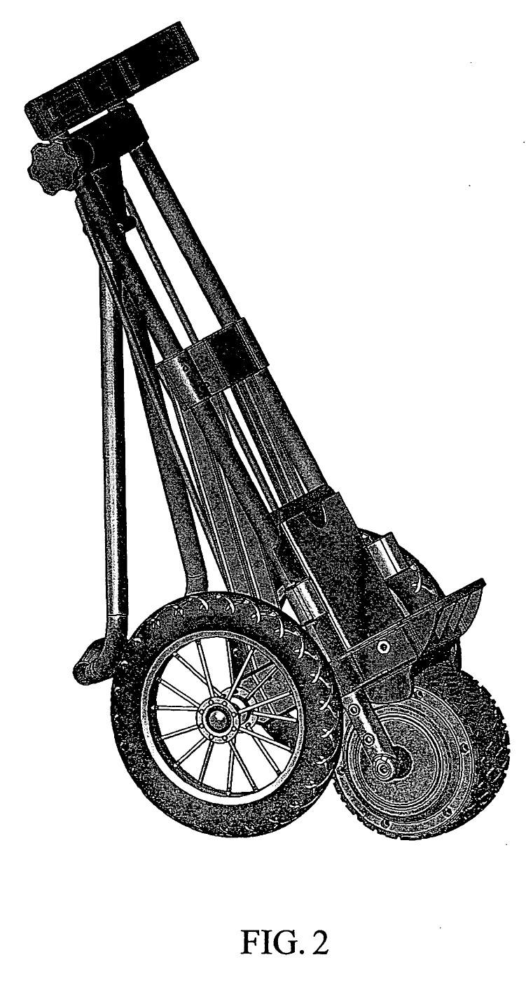

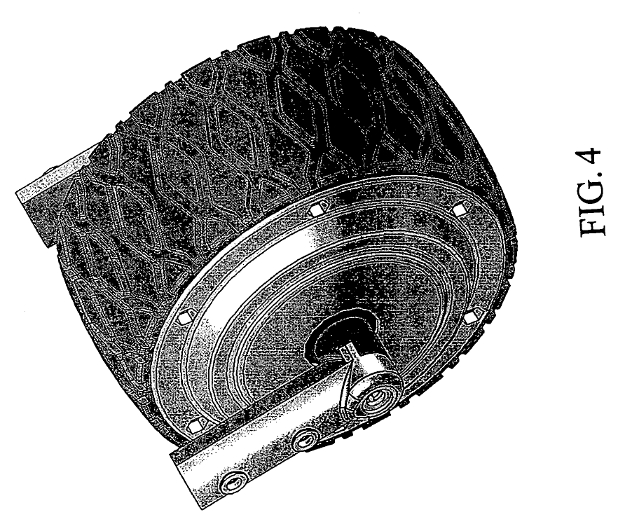

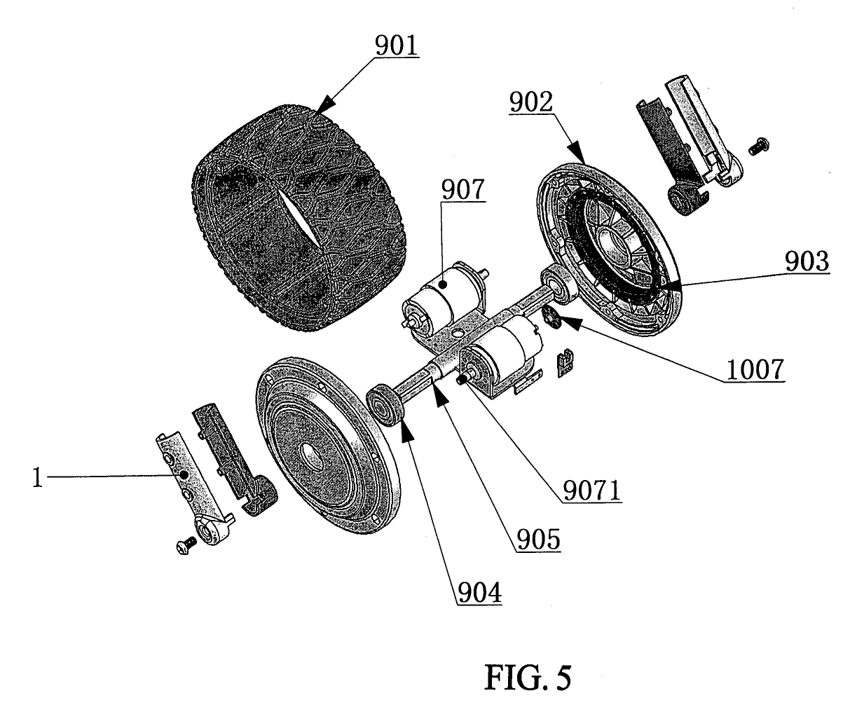

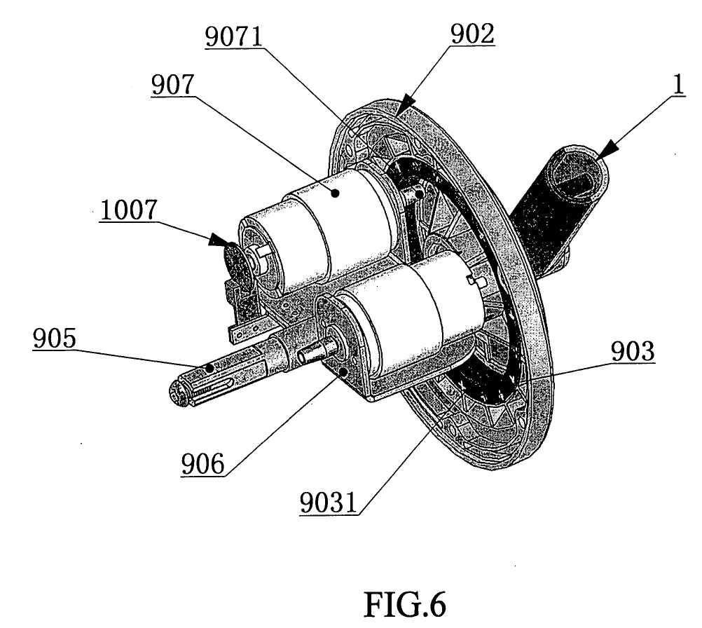

Now referring to FIGS. 2 through 5, the drive wheel according the present invention comprises a tire 901, a boss 902, a friction ring 903 coupled to the boss, an axle bearing 904, a wheel axle 905, a motor 907 and a bracket for the motor 906 (as shown in FIG. 5); the assembly comprising the above parts is enclosed in a space formed by the folded tire and the boss (as shown in FIG. 4). A rolling friction face 9031 is formed on the friction ring 903 along the inner circumference thereof (as shown in FIG. 6). The motor 907 is provided with a output axis 9071 reaching out at the two ends thereof and the motor 907 is coupled to the bracket for the motor 906 that is coupled to the wheel axle 905 connecting to the boss 902 through the rolling bearing 904 (as shown in FIG. 6). An optical counter 1007 is provided on one end of the output axis 9071 of the motor. (as shown in FIG. 6).

After the motor is powered on, the motor will rotate and the output axis 9071 will have rolling friction with a friction face 9031 of the friction ring 903 and thus making the boss rotate. Two motors respectively driving a left boss and a right boss are controlled by the control portion so that they operate synchronously. At the same time, the optical counter 1007 provided on one end of the output axis 9071 rotates with the motor so as to measure the rotate speed of the motor.

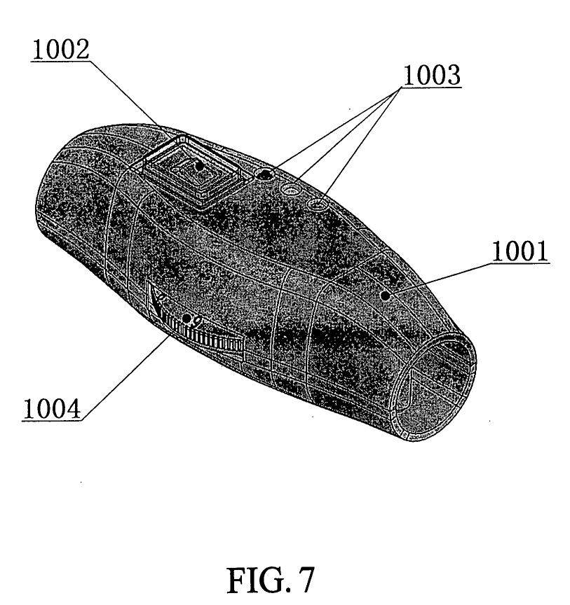

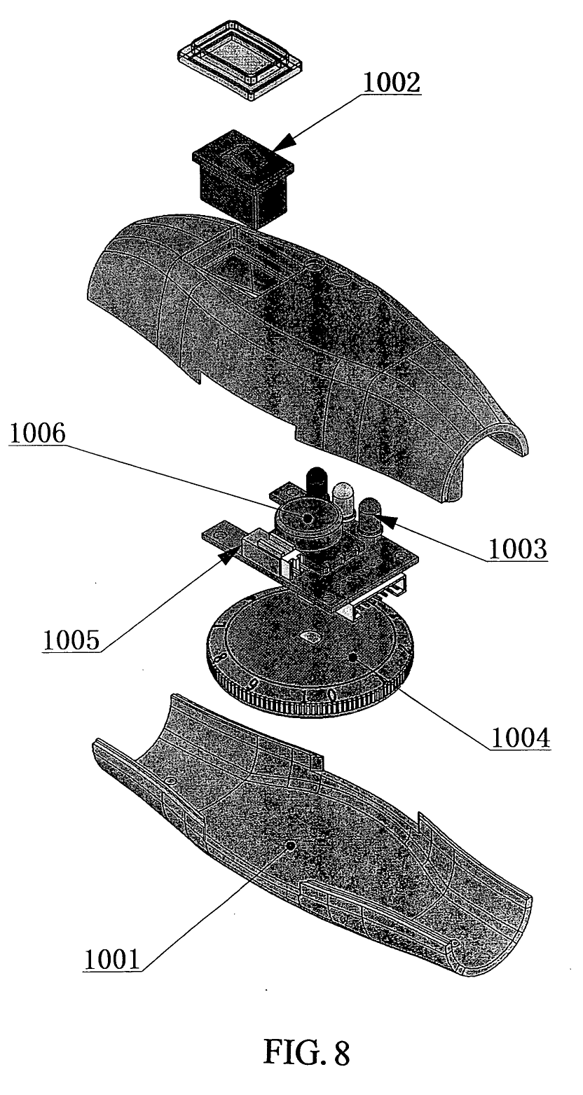

Now referring to FIGS. 7 and 8, the traveling speed of the present invention is predetermined and controlled by the PC control system to keep the traveling speed as predetermined under different operating conditions, for example, ascending, descending or uneven surface. The speed control system comprises the speed regulator 10, the optical counter 1007 provided on the output axis 9071 of the motor, and a PC circuit board enclosed in the case for PC circuit board.

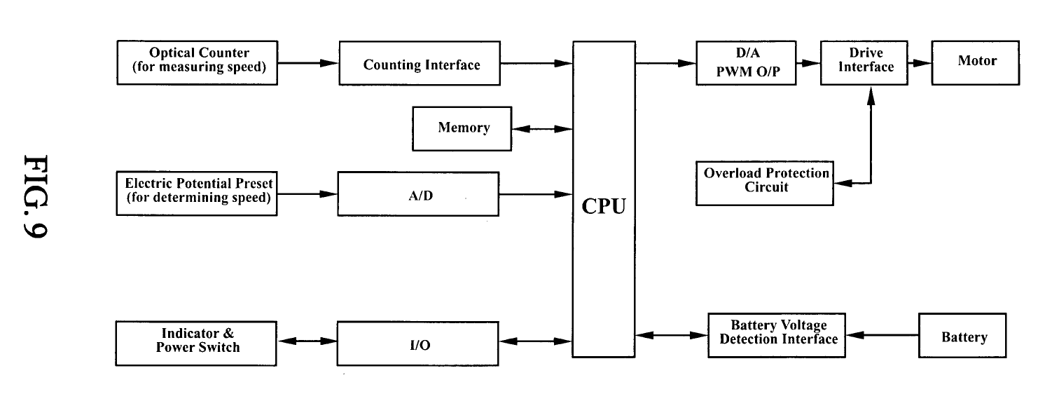

Now referring to FIG. 9, the resistance value of a variable resistor for speed control 1006 in order to regulating the traveling speed is adjusted by turning a regulating knob 1004 provided on the speed regulator 10. The voltage value set by the variable resistor for speed control 1006 is transmitted to a central process unit (CPU) via a D/A interface and output to a drive interface by way of PWM to rotate the motor. The rotate speed of the motor can be changed by altering the bandwidth without changing the output voltage. When the traveling speed changes, the optical counter 1007 transmits a signal to CPU via the A/D interface. The signal is then processed by the CPU and output to the drive interface via the D/A interface by way of PMN, such that the output power is automatically changed according the changes of the load. For example, the output power will increase when traveling on an ascending surface and decrease when traveling on a descending surface to maintain the predetermined the traveling speed. At the same time, a the load of the motor is monitored by a overload circuit monitor, and the battery voltage is detected by a battery voltage detecting interface in order to avoid overload and overcharge of the battery by display the battery voltage status by a indicator via an I/O interface.

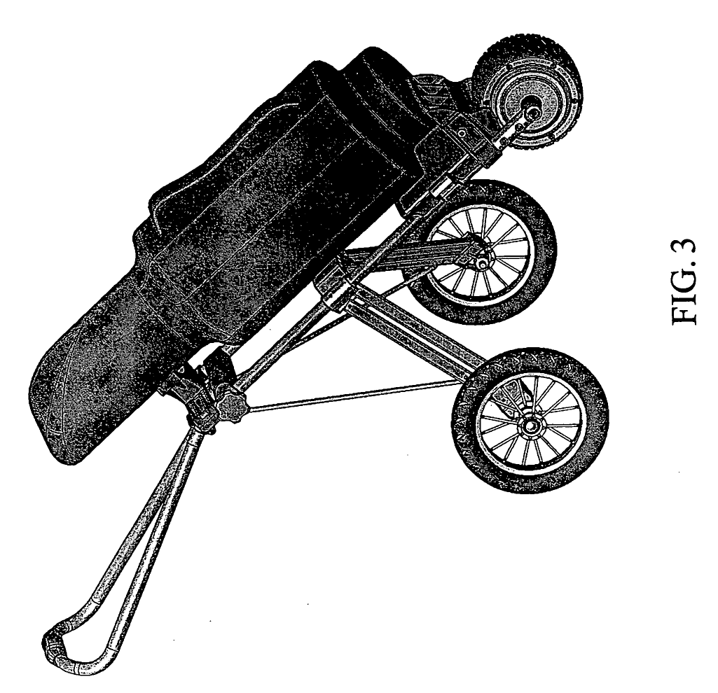

Now referring to FIG. 2, in the powered golf bag vehicle with speed control according to the present invention, wheels 6 and a drive wheel 9 forms a tripod structure (as shown in FIG. 1) through a foldable handle with latching device 4, a foldable support with connecting rod 5, and a frame 1; and a main body for carrying objects (as shown in FIG. 3) is formed by, and a golf bag supporter 2, a golf bag holder 3, a battery case 7, and a frame 1. The foldable handle and latching device 4 and the foldable support with connecting rod 5 can be folded for storage and carriage. The above description of the embodiment is only a preferred one but by no means limitation of the present invention. Those skilled in the art can make modifications and equivalent arrangements within spirit and scope of the invention.

1. A powered golf bag vehicle with speed control comprising:
a drive portion;
a speed control portion;
a main body portion;
a foldable portion; and
a traveling portion;
wherein the main body portion being supported by the traveling portion and the foldable portion, the foldable portion being coupled to an upper part of the main body portion, the drive portion being connected to the traveling portion, and the traveling speed of the vehicle being predetermined and controlled by means of the speed control portion provided on the upper end of the main body portion and the traveling portion.

2. The powered golf bag vehicle with speed control according to claim 1, wherein said drive portion comprising a battery case, a built-in motor and a drive wheel; said main body portion comprising a frame, a golf bag supporter, a golf bag holder and a battery case; said foldable portion comprising a foldable handle with latching device, a foldable support with connecting rod; said traveling portion comprising a drive wheel, a wheel and a wheel axle.

3. The powered golf bag vehicle with speed control according to claim 2, wherein said drive wheel comprising a tire, a boss, a friction ring coupled to the boss, an axle bearing, a wheel axle, a motor and a bracket for the motor and being enclosed in a space formed by the folded tire and the boss, wherein the motor being provided with a output axis reaching out at the two ends thereof and being coupled to the bracket for the motor coupled to the wheel axle connecting to the boss through the rolling bearing.

4. The powered golf bag vehicle with speed control according to claim 3, wherein a rolling friction face being formed on said friction ring along the inner circumference thereof.

5. The powered golf bag vehicle with speed control according to claim 1, wherein said speed control portion comprising a speed regulator, an optical counter provided on the output axis of the motor and a PC circuit board provided with a case.
